(19) United States
(12) Patent Application Publication
(10) Pub. No.: US 2026/0103079 A1
(43) Pub. Date: Apr. 16, 2026

(54) USER INTERFACE ADJUSTMENT ON A VEHICLE DISPLAY

(71) Applicant: Rivian IP Holdings, LLC, Irvine, CA (US)

(72) Inventors: Aravind ASOKAN, Sunnyvale, CA (US); Jingying LIN, San Mateo, CA (US); Di BAO, San Francisco, CA (US); Thomas Buck SLEEPER, Mission Viejo, CA (US); Martynas Christopher LAURITA, Portland, OR (US); Nora Valeria CALABRESE, Mountain View, CA (US); James CHOW, Irvine, CA (US)

(21) Appl. No.: 19/344,402

(22) Filed: Sep. 29, 2025

Related U.S. Application Data
(60) Provisional application No. 63/707,750, filed on Oct. 15, 2024.

(51) Int. Cl. B60K 35/81; B60K 35/22; B60K 35/28

(52) U.S. Cl. CPC B60K 35/81; B60K 35/22; B60K 35/28; B60K 2360/166; B60K 2360/167; B60K 2360/171; B60K 2360/1876

(57) ABSTRACT

A display in a vehicle may present various UI elements at certain regions on the vehicle. Based upon the type of rendered UI element, other UI elements may be resized, replaced, or re-positioned. The display is designed to present coordinated UI elements rendered by different operating systems.

### CROSS REFERENCE TO RELATED APPLICATION(S)

The present application claims the benefit of U.S. Provisional Application No. 63/707,750, entitled “USER INTERFACE ADJUSTMENT ON A VEHICLE DISPLAY”, filed Oct. 15, 2024, the entirety of which is incorporated herein for reference.

### INTRODUCTION

This application is directed to visual information, such as user interface (UI) elements, presented on displays in vehicles, and more particularly, to adjusting the visual information on displays based on factors such as prioritization and/or urgency.

### SUMMARY

Vehicles include a display designed to present visual information, or visual content, to users on a display in the form of notifications, widgets, UI elements, visual content boxes/windows, or a combination thereof. Examples of visual information include navigation, which may include a map and a turn-by-turn navigation. In some instances, an event (e.g., high priority event) is detected by the vehicle. The event may be provided as a notification UI element on the display and preceded by re-sizing or removing other UI elements in favor of the notification UI element.

In one or more aspects of the present disclosure, a method is described. The method may include rendering, via a first operating system and on a display for a vehicle, a first user interface (UI) element and a second UI element. The method may further include in response to an indication of an event, via the first operating system and on the display, adjusting the first UI element and the second UI element.

The method may further include in response to the indication of the event rendering, via the first operating system and on the display, a third UI element to replace the first UI element, and rendering, via a second operating system and on the display, a fourth UI element superimposed over the second UI element, wherein the fourth UI element is associated with the event.

The fourth UI element may include a notification UI associated with the vehicle. The fourth UI element may include a notification UI associated with a call notification for a passenger of the vehicle. The first UI element, the second UI element, and the third UI element may include navigational UI. At least some of the first UI element and the second UI element may be combined to render the third UI element.

The method may further include rendering, via the second operating system and on the display, a fifth UI element associated with a speed of the vehicle. The third UI element may include only text information. The fourth UI element may include an emergency notification.

In one or more aspects of the present disclosure, a device is described. The device may include a display configured to present visual information for a vehicle; memory. The device may further include one or more processors configured to execute instructions stored on the memory. The instructions may include rendering, via a first operating system and on the display, a first user interface (UI) element, wherein the first UI element occupies a first area on the display. The instructions may include in response to an indication of an event: rendering, via the first operating system and on the display, the first UI element to occupy a second area on the display, the second area less than the first area, and rendering, via a second operating system and on the display, a second UI element that at least partially occupies the first area, wherein the second UI element is associated with the event.

The second UI element may include a notification UI associated with the vehicle. The notification UI may include an emergency notification UI. The instructions may further include in response to the indication of the event: rendering, via the first operating system and on the display, the first UI element to occupy a third area on the display, the third area less than the second area, and rendering, via the second operating system and on the display, a third UI element that at least partially occupies the second area, wherein the third UI element is associated with the event.

The instructions may further include in response to the indication of the event: the first UI element may include a first portion of a navigation UI, and the second UI element may include a second portion of the navigation UI. The first portion may include an environment in which the vehicle is located, and the second portion may include turn instructions. The second UI element may include a widget UI selected from one of a media UI, a windshield wiper UI, a battery efficiency UI, or a tire pressure UI.

The instructions may further include receiving, via one or more sensors, data corresponding to the event.

In one or more aspects of the present disclosure, a non-transitory computer-readable medium is described. The non-transitory computer-readable medium may include computer-readable instructions that, when executed by a processor, cause the processor to perform one or more operations. The one or more operations may include rendering, via a first operating system and on a display for a vehicle: a first user interface (UI) element at first location of the display. The first UI element may include navigation information. A second UI element may be rendered that includes an environment in which the vehicle is located. The one or more operations may further include rendering, via a second operating system and on the display, a third UI element associated with a speed of the vehicle. The one or more operations may further include in response to an indication of an event, automatically rendering, via the second operating system and on the display, a fourth UI element at the first location, wherein the fourth UI element is associated with the event.

The first UI element occupies a first area on the display. The one or more operations may further include in response to the indication of the event: rendering, via the first operating system and on the display, the first UI element to occupy a second area on the display, the second area less than the first area, and rendering, via the second operating system and on the display, the fourth UI element to at least partially occupy the first area.

The one or more operations may further include in response to the indication of the event, superimposing the fourth UI element over first UI element. The fourth UI element may be selected from a notification UI or a widget UI.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with aspects of the present disclosure.

FIG. 2 illustrates a side view of an alternate example of a vehicle, in accordance with aspects of the present disclosure.

FIG. 3 illustrates a perspective view of an example interior of a vehicle, in accordance with aspects of the present disclosure.

FIG. 4 illustrates a block diagram of a vehicle, in accordance with aspects of the present disclosure.

FIG. 5 illustrates a diagram showing features of a display for a vehicle, in accordance with aspects of the present disclosure.

FIG. 6A, FIG. 6B, and FIG. 6C illustrate examples of user interface (UI) elements presented on a display of a vehicle, in accordance with aspects of the present disclosure.

FIG. 7A, FIG. 7B, FIG. 7C, FIG. 7D, and FIG. 7E illustrate examples of UI elements presents on a display of a vehicle, in accordance with aspects of the present disclosure.

FIG. 8 and FIG. 9 illustrate examples of UI elements in the form of emergency-based notifications that may be rendered on a display, in accordance with aspects of the present disclosure.

FIG. 10, FIG. 11, and FIG. 12 illustrate flow diagrams showing example processes that may be performed for managing a display in a vehicle, in accordance with implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to adjustment of UI elements, in the form of visual information presented on a vehicle display, based on various factors. In one or more implementations, the size (e.g., area occupied on a display) of a UI element is adjusted based on predefined priority and/or preference parameter(s) that is/are determined based on an event detected by the vehicle by, for example, one or more sensors of the vehicle. These detected events may be prioritized and presented as a UI element on the display that either replaces or is superimposed over another UI element. For example, a UI element may be removed from the display in favor of higher priority UI element that provides a critical notification to the vehicle driver and/or other vehicle passengers. In another example, the size of the UI element may be adjusted (e.g., reduced in size) to provide area for a high-priority UI element to occupy the area that was previously occupied by the adjusted/resized UI element. The logic for determining whether to adjust the size of a UI element or remove the UI element may rely on the context of the new/additional UI element(s), with the context accounting for prioritization and/or urgency. The present disclosure provides a uniform and structured approach to providing visual information on a display at certain predetermined locations. Beneficially, the display space may be more efficiently used and provide a more predictable user experience by rendering certain UI element at a predictable location on the display for passengers to view.

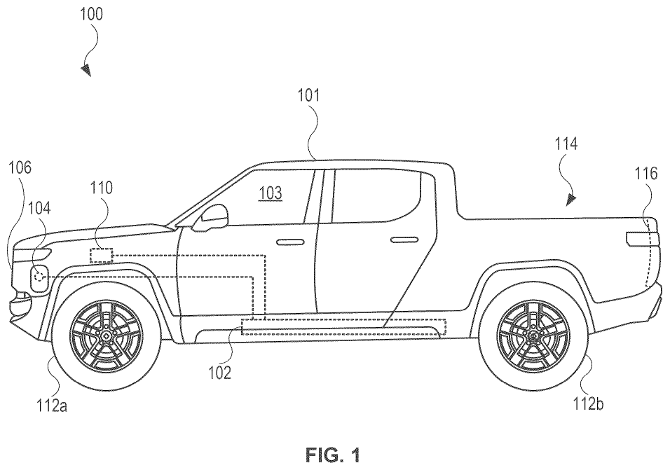

FIG. 1 illustrates a side view of an example of a vehicle 100, in accordance with one or more aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be carried by a vehicle body 101 of the vehicle 100, with the vehicle body 101 defining a cabin 103 that provides a space for passengers. The battery pack 102 may be coupled (e.g., electrically coupled) to one or more electrical systems of the vehicle 100 to provide power to the one or more electrical systems. For example, the vehicle 100 may include a port 104 (e.g., charge port) designed to receive a cable connector (not shown in FIG. 1) used to transmit power (e.g., alternating current (AC) power) that is converted to direct current (DC) power to charge the battery pack 102. The vehicle 100 may further include a front end 106 at which one or more lamps (shown below) are generally positioned.

As another exemplary electrical system, the vehicle 100 may include a drive unit 110, representative of one or more additional drive units of the vehicle 100. The battery pack 102 may couple to the drive unit 110. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100.

The vehicle 100 may further include a bed 114 that may be used as a storage area for the vehicle 100. In order to access the bed 114, the vehicle 100 may further include a gate 116. Based on its position on the vehicle 100, the gate 116 may take the form of a closure, such as a rear gate or a tailgate. The gate 116 is designed to open, via rotation, thereby allowing further access to the bed 114.

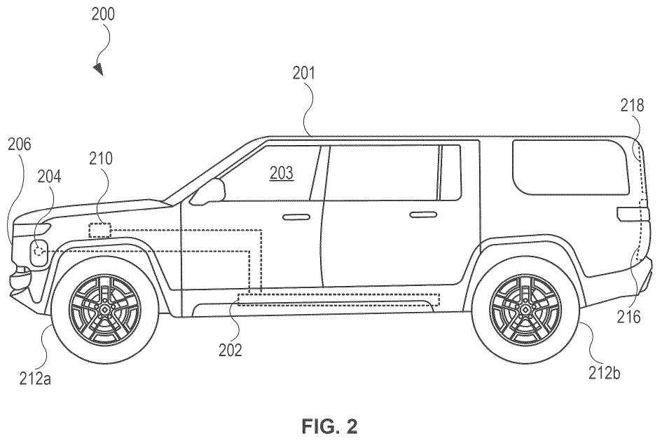

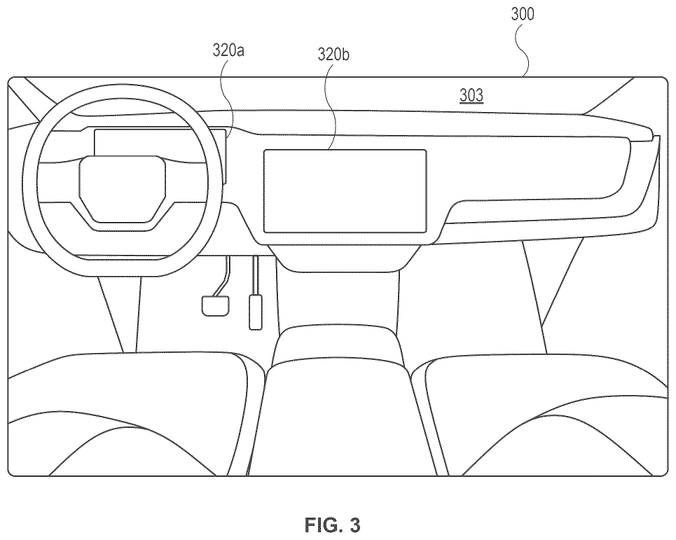

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a vehicle body 201, a battery pack 202, a cabin 203, a port 204 (e.g., charge port), a front end 206, a drive unit 210 (representative of one or more additional drive units), a wheel 212a (representative of an additional front wheel), and a wheel 212b (representative of an additional rear wheel).

The cabin 203 of the vehicle 200 may extend to a rear portion of the vehicle 200. In order to access the rear portion of the cabin 203, the vehicle 200 may further include a gate 216. Based on its position on the vehicle 200, the gate 216 may take the form of a rear gate or a liftgate. The gate 216 is designed to open, via rotation, thereby allowing access to the cabin 203. Additionally, the vehicle 200 may include an enclosure 218. In one or more implementations, the enclosure 218 takes the form of a glass panel. Similar to the gate 216, the enclosure 218 is designed to open, via rotation, thereby allowing further access to the cabin 203.

FIG. 3 illustrates a perspective view of an example interior of a vehicle 300, in accordance with aspects of the present disclosure. The vehicle 300 may include any features shown and/or described herein for the vehicles 100 and 200 shown in FIG. 1 and FIG. 2, respectively. The vehicle 300 may include a cabin 303 that defines an interior space. The vehicle 300 may further include a display 320a and a display 320b. Each of the displays 320a 320b may take the form of an light-emitting diode (LED) display, an organic LED display (OLED), as non-limiting examples. Also, each of the displays 320a and 320b is designed to present visual information in the form of text-based information (e.g., words), still images (e.g., pictures), and/or motion images (e.g., video). In this regard, each of the displays 320a and 320b may present various UI elements. This will be shown and described in further detail below.

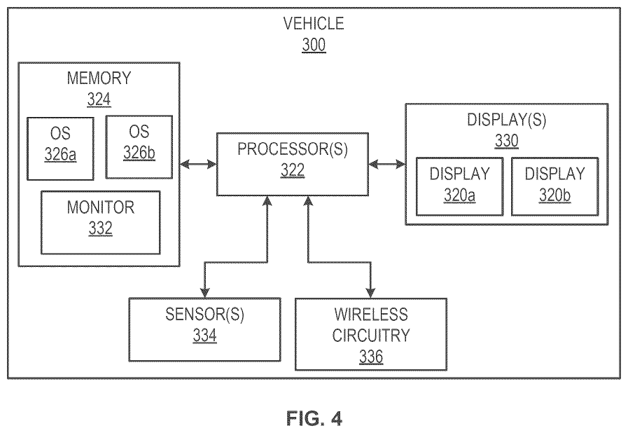

FIG. 4 illustrates a block diagram of the vehicle 300, in accordance with aspects of the present disclosure. As shown, the vehicle 300 may include one or more processors 322 designed to monitor components and/or provide commands to other components. The one or more processors 322 may include one or more controllers, such as a central processing unit, a graphics processing unit, a microelectromechanical systems (MEMS) controller, and/or one or more microcontrollers. In one or more embodiments, the one or more processors 322 are communicatively coupled (e.g., in communication with), and configured to provide commands to, various components of the vehicle 300 shown in FIG. 4.

The vehicle 300 may further include memory 324 that stores instructions (e.g., computer-readable and executable instructions) for the one or more processors 322. As non-limiting examples, the memory 324 may include random access memory and/or read-only memory. The memory 324 may store multiple operating systems. For example, the memory 324 may store an operating system 326a (“OS”) and an operating system 326b (“OS”). In one or more implementations, the one or more processors 322 utilizes the operating system 326a to render UI elements, such as navigational UI (e.g., maps), environment UI (e.g., the vehicle 300 and surrounding vehicles), camera-based UI (e.g., rear view motion images, blind spot motion images), and widget UI (e.g., media player UI, windshield wiper UI, vehicle efficiency UI, tire UI). In this regard, the one or more processors 322 may utilize the operating system 326a to render and provide real-time, dynamic UI elements. Moreover, the one or more processors 322 may utilize the operating system 326a to resize (e.g., enlarge, reduce) the area of the rendered UI element(s) on a display.

In one or more implementations, the one or more processors 322 utilizes the operating system 326b to render additional UI elements, such as emergency notification UI elements (e.g., unlatched hood, ADAS, emergency call, warning) and real-time vehicle information UI elements (e.g., vehicle speed, vehicle transmission position such as park, reverse, neutral, drive and low). In this regard, the one or more processors 322 may utilize the operating system 326b to render notification UI elements based on an event associated with a relatively high priority situation.

However, the operating system 326b may be configured to render relatively less dynamic UI elements. For example, whereas the one or more processors 322 may utilize the operating system 326a to render dynamic UI elements such as a rendered image of the vehicle 300 moving relative to other vehicles in a real-world environment based on data obtained by a camera, the operating system 326b may be limited to include only text-based UI (e.g., only text information) and/or a still image UI. However, based on the limited UI rendering capabilities, the operating system 326b may be more stable relative to the operating system 326a, and accordingly, the operating system 326b is more likely to operate in a reliable manner and less likely to be involved in an event, as compared to operating system 326a. In this regard, if the operating system 326a become unstable or inoperable, the operating system 326b may nonetheless provide emergency-based and/or urgency-based notification in the form of UI elements. Beneficially, by relying on multiple operating systems (e.g., operating systems 326a and 326b) that operate in accordance with at least some distinctions, the vehicle 300 is more than traditional vehicles to provide, via the one or more displays 330, user notifications in the form of emergency-based and/or urgency-based UI elements to passengers.

In one or more implementations, the one or more processors 322 utilizes the operating system 326b to render one or more UI elements over (e.g., superimposed, overlapped) one or more UI elements rendered via the operating system 326a. Alternatively, or in combination, the one or more processors 322 utilizes the operating system 326a to resize (e.g., reduce the area of) one or more UI elements rendered via the operating system 326a, and utilizes the operating system 326b to render one or more UI elements at a location previously occupied by the one or more UI elements (e.g., prior to reducing the area) rendered by the operating system 326a.

The vehicle 300 may further include one or more displays 330. The one or more displays 330 may take the form of one or more of the display 320a or the display 320b (both shown in FIG. 3). The one or display 330 may take the form of a capacitive touch input display that uses user interactions (e.g., touch inputs, gestures) to receive a command or instruction. The memory 324 may further store a monitor 332 (e.g., monitoring program). As a non-limiting example, the monitor 332 may take the form of a hypervisor designed to enable the one or more processors 322 to run multiple virtual machines, with each machine having a respective operating system and resources. In one or more implementations, the one or more processors 322 runs or operates each of the operating system 326a and 326b on a respective virtual machine and subsequently utilizes the monitor 332 to combine one or more UI elements rendered from each of the operating systems 326a and 326b on a display (e.g., display 320a) of the one or more displays 330.

The vehicle 300 may further include one or more sensors 334. As non-limiting examples, the one or more sensors 334 may include one or more images sensors, one or more proximity sensors (e.g., steering wheel engagement sensors), pressure sensors (e.g., tire pressure sensors), voltmeters, current sensors, rain sensor(s), and/or a global positioning system (GPS) transceiver. The one or more images sensors may take the form of one or more cameras and/or a light detection and ranging (LIDAR) system, each of which may be used to determine environmental information relative to the vehicle 300. The one or more proximity sensors may include a metal detection sensor, a capacitive sensor, and/or a distance sensor (e.g., light sensor, laser sensor). The one or more sensors 334 may detect an input and communication an event to the one or more processors 322. For example, when the one or more sensors 334 includes a proximity sensor(s) designed to detect a position of a latch for a hood and/or a door of the vehicle 300, the one or more sensors 334 may provide, based on the position of the latch, data to the one or more processors 322 indicating the hood and/or door, respectively, is open. Based on the hood and/or door being opening, the one or more processors 322 may instruct one or more of the operating system 326a or the operating system 326b to render a UI element on a display of the one or more displays 330 that the hood and/or the door, respectively, is open.

In one or more implementations, the operating systems 326a and 326b render respective UI elements based on the context of a detected event, with the detected event being detected by, for example, the one or more sensors 334. The positioned of a latch, the depression of a button within a front trunk, or frunk, of a vehicle, or external hazard are representative examples of context-based events that trigger the operating systems 326b to render a UI element associated with the event that is superimposed (or overlapped) over a UI element rendered by the operating systems 326a, or that trigger the operating systems 326a to resize a rendered UI element to provide area for a UI element, associated with the event, rendered by the operating systems 326b.

In one or more implementations, the memory 324 may include a single operating system (e.g., operating system 326a) that can not only render an initial UI element(s) but also replace or superimpose the initial UI element(s) with a subsequent UI element(s).

The vehicle 300 may further include wireless circuitry 336. As non-limiting examples, the wireless circuitry 336 may be used to form a cellular network, a GPS network, and/or a WI-FI® network. Accordingly, the vehicle 300 may communicate, via the wireless circuitry 336, voice-enabled calls, including emergency and non-emergency calls. In one or more implementations, the wireless circuitry 336 may also detect a context-based event, such as an emergency call or another emergency notification.

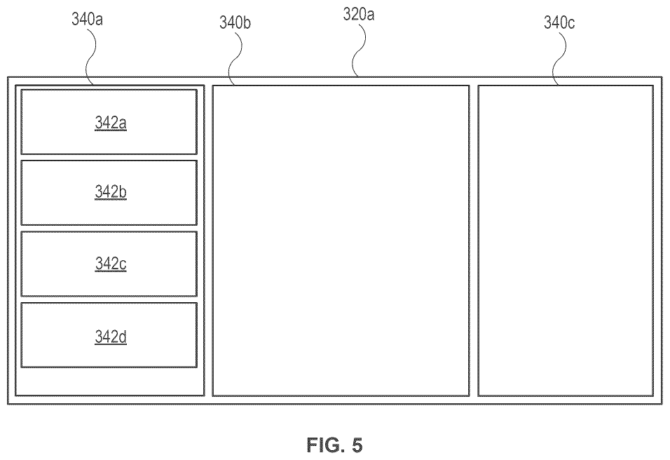

FIG. 5 illustrates a diagram showing features of a display 320a for a vehicle (e.g., vehicle 300 shown in FIG. 3), in accordance with aspects of the present disclosure. The display 320a may be partitioned into multiple regions. For example, the display 320a may be partitioned into a region 340a, a region 340b, and a region 340c. Various UI elements may be presented at the display 320a within at least one of the regions 340a, 340b, and 340c. Moreover, at least some of the regions 340a, 340b, and 340c may be further partitioned into locations, or sub-regions. For example, the region 340a of the display 320a may be partitioned into a location 342a, a location 342b, a location 342c, and a location 342d. Each of the locations 342a, 342b, 342c, and 342d within the region 340a may be utilized to present a UI element in the form of a widget, a notification, or a control. As non-limiting examples, a UI element taking the form of a widget may include a monitored device of a vehicle, such as a media playback volume, battery efficiency, location information, or tire pressure. As non-limiting examples, a UI element taking the form of a notification may include an event-based UI element, such as an incoming call. As non-limiting examples, a UI element taking the form of a control may include a media playback selection. By consistently locating UI elements, in the form of widgets, notifications, or controls, at a particular region, passengers in the vehicle with the display 320a may become accustomed to viewing these UI elements at the same or substantially similar location. Each of the locations 342a, 342b, 342c, and 342d may occupy the same area (e.g., height and width) within the region 340a.

Additionally, in one or more implementations, one or more of the locations 342a, 342b, 342c, and 342d may be combined. For example, the locations 342a and 342b may be combined to present a UI element at a combined location corresponding to the locations 342a and 342b. As another example, the locations 342a, 342b, 342c, and 342d may be combined to present a UI element at a combined location corresponding to the locations 342a, 342b, 342c, and 342d. Subsequently, the combined location may be re-partitioned to each of the locations 342a, 342b, 342c, and 342d, or to some combination of one or more of the locations 342a, 342b, 342c, and 342d, thereby allowing for multiple UI elements at the region 340a of different areas.

Additional UI elements may be represented on the display 320a at one or more of the region 340b or the region 340c. For example, the region 340b may be used to provide UI elements corresponding to environmental information (based on the vehicle's surroundings) or speed information. Further, the region 340c may be used to provide UI elements such as vehicle speed UI, vehicle battery charge UI, vehicle mode UI, camera display UI (e.g., blind spot), and transmission state UI. Also, the one or more processors 322 (shown in FIG. 4) may utilize each of the operating systems 326a and 326b (shown in FIG. 4) to render UI elements in any one or more of the regions 340a, 340b, or 340c. While the foregoing example is shown as being applicable to the display 320a, the display 320b (shown in FIG. 3) may be utilized in the same or similar manner.

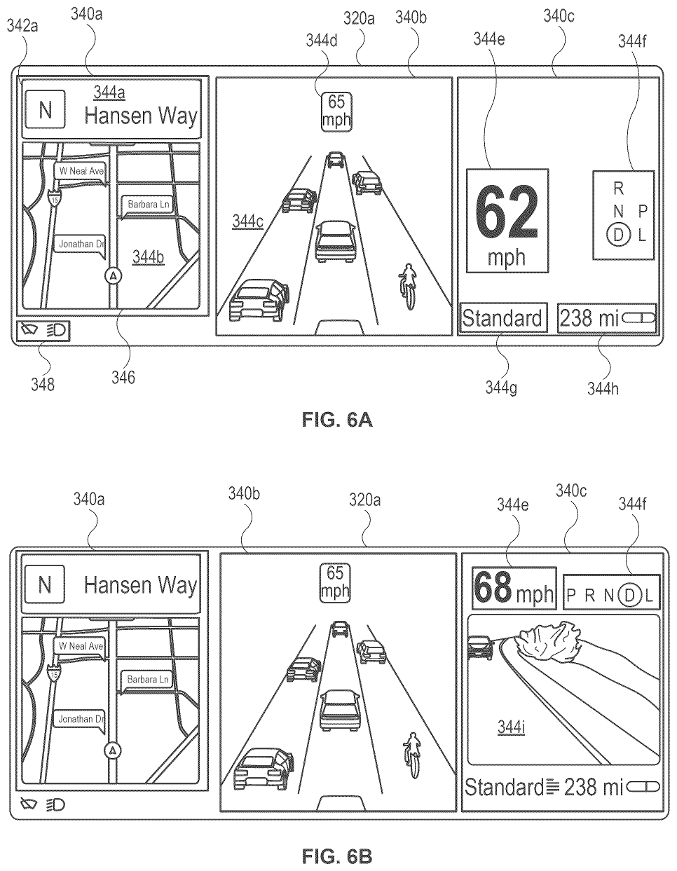

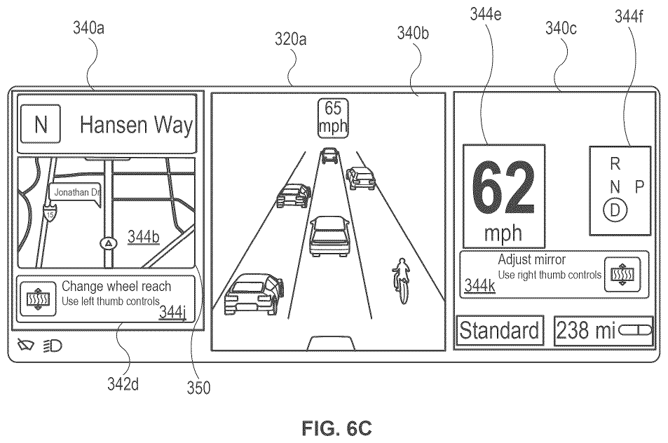

FIG. 6A, FIG. 6B, and FIG. 6C illustrate examples of UI elements presented on a display 320a of a vehicle (e.g., vehicle 300), in accordance with aspects of the present disclosure. The various UI elements rendered on the display 320a shown in FIGS. 6A-6C are intended to be exemplary and non-limiting.

Referring to FIG. 6A, the region 340a includes a UI element 344a in the form of a navigation UI (e.g., current road on which the vehicle is located, turn-by-turn navigation) at the location 342a. The region 340a further includes a UI element 344b in the form of an additional navigation UI (e.g., map and current location of the vehicle on the map) at a location 346 of the display 320a, with the location 346 representing an area corresponding to a combination of the locations 342b, 342c, and 342d (shown in FIG. 5). In one or more implementations, the UI elements 344a and 344b are rendered using the operating system 326a (shown in FIG. 4).

The region 340b may include a UI element 344c in the form of an environmental UI element (e.g., the vehicle and vehicles surrounding the vehicle). The region 340b may further include a UI element 344d in the form of a speed limit UI (e.g., speed limit for the road on which the vehicle is located). In one or more implementations, the UI elements 344c and 344d are rendered using the operating system 326a (shown in FIG. 4).

The region 340c may include a UI element 344e in the form of current speed UI (e.g., current speed of the vehicle). The region 340b may further include a UI element 344f in the form of a transmission state UI (e.g., current state of the vehicle's transmission). In one or more implementations, the UI elements 344c and 344d are rendered using the operating system 326b (shown in FIG. 4). In this regard, the display 320a may presented coordinated UI elements from each of the operating systems 326a and 326b. The region 340c may further include a UI element 344g in the form of current vehicle mode UI (e.g., Standard, All-Purpose, Snow, Tow, Conserve, All-Terrain, Soft Sand, Rock Crawl, Drift, and Rally). The region 340c may further include a UI element 344h in the form of vehicle battery UI (e.g., drive miles remaining based on the vehicle's current battery charge level). In one or more implementations, the UI elements 344g and 344h are rendered using the operating system 326a (shown in FIG. 4).

Additional UI elements may be rendered on the display 320a outside of the regions 340a, 340b, and 340c. For example, UI elements may include a UI element 348 in the form of a windshield wiper UI and a headlamp UI. In one or more implementations, the UI element 348 is rendered using the operating system 326b (shown in FIG. 4).

Referring to FIG. 6B, the UI elements, including the respective layouts, in the regions 340a and 340b may be the same or substantially similar to those shown in FIG. 6A. However, the UI elements in the region 340c may be substituted and/or altered with other UI elements. For example, the UI elements 344e and 344f may be moved to a different location within the region 340c, and the font size may be altered. Based on the UI elements 344e and 344f be re-positioned, the region 340c may further present a UI element 344i in the form of real-time, or near real-time, video data using, for example, a camera of the vehicle. As shown, the UI element 344i may provide a imagery of the vehicle's blind spot.

Referring to FIG. 6C, the UI elements, including the respective layouts, in the region 340b may be the same or substantially similar to those shown in FIG. 6A. However, the UI elements in the regions 340a and 340c may be substituted and/or altered with other UI elements. For example, the UI element 344b may be rendered in a location 350, with the location 350 representing an area corresponding to a combined location of the locations 342b and 342c (shown in FIG. 5). As compared to the area defined by the location 346 (shown in FIG. 6A), the area defined by the location 350 may be less than the area defined by the location 346, while the UI element 344b in the location 350 is rendered with the same, or substantially, similar features/data as those shown in the UI element 344b in the location 346 in FIG. 6A.

Based on the location 350 occupying a lesser area in the region 340a of the display 320a, the location 342d of the region 340a may utilized to present additional UI. For example, a UI element 344j may be rendered at the location 342d, with the location 342d representing a previously occupied location by the UI element 344b. As shown, the UI element 344j may take the form of a control UI (e.g., control for adjusting a steering wheel of the vehicle).

The UI elements 344e and 344f (both in the region 340c) may be re-positioned to provide space for a UI element 344k. As shown, the UI element 344j may take the form of a control UI (e.g., control for adjusting a mirror of the vehicle). Each of the UI elements 344j and 344k may be referred to as spatial UI elements. In this regard, the position of the UI elements 344j and 344k on the display 320a may appear on either of the regions 340a and 340c of the display 320a, based in part on the physical location of the control (e.g., button, scroll wheel).

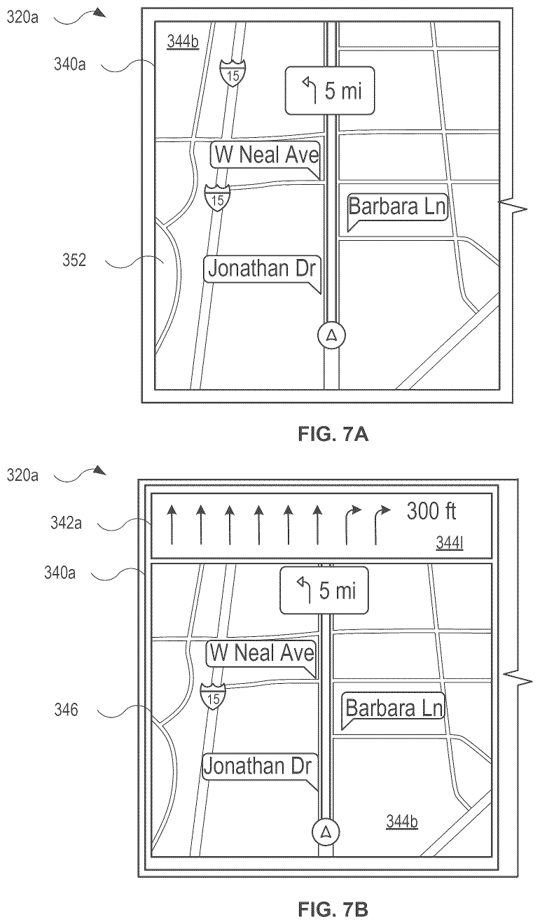

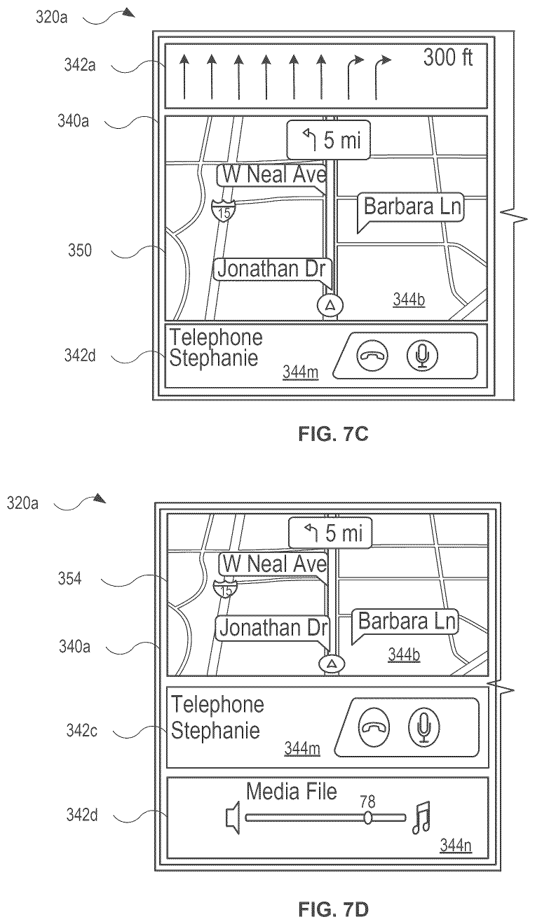

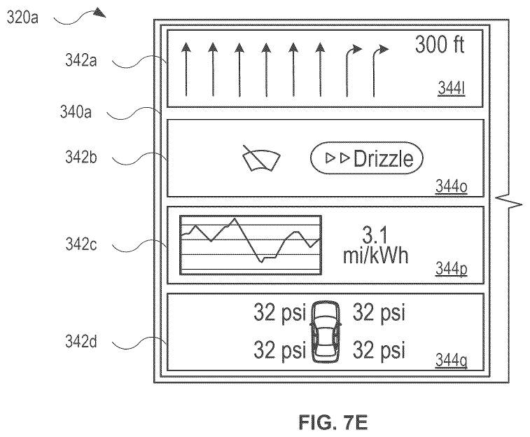

FIG. 7A, FIG. 7B, FIG. 7C, FIG. 7D, and FIG. 7E illustrate examples of UI elements presents on a region 340a of the display 320a of a vehicle (e.g., vehicle 300 shown in FIG. 4), in accordance with aspects of the present disclosure. The UI elements shown in FIGS. 7A-7F, including the type, location and area, are intended to be exemplary and non-limiting. Also, the UI elements shown in FIGS. 7A-7F may be rendered using at least one of the operating system 326a or the operating system 326b (both shown in FIG. 4).

Referring to FIG. 7A, the UI element 344b may occupy the region 340a in its entirety. Put another way, each of the locations 342a, 342b, 342c, and 342d (shown in FIG. 5) may be combined to define a location 352 for the UI element 344b. Also, he map UI information defining the UI element 344b may be derived in part by the one or more sensors 334 (shown in FIG. 4).

Referring to FIG. 7B, the area of the UI element 344b may be reduced, while still generally showing the same information, to occupy the location 346, representing a combination of the locations 342b, 342c, and 342d (shown in FIG. 5). As shown, the area of the location 346 is less than the area of the location 352 (shown in FIG. 7A). In this regard, the location 342a of the region 340a may be utilized for rendering a UI element 344l that takes the form of a maneuver UI (e.g., lane turn information, distance information). As an example, the area of the UI element 344b may be automatically reduced to the location 346 based on the vehicle approaching an exit or turn in accordance with driving direction to a predetermined location requested by a user.

Referring to FIG. 7C, the UI element 344b is reduced to the location 350, represented by the locations 342b and 342c (shown in FIG. 5). As shown, the area of the location 350 is less than the area of the location 346 (shown in FIG. 7B). In this regard, the location 342d of the region 340a may be utilized for rendering a UI element 344m that takes the form of a phone call notification UI (e.g., incoming call notification). The phone notification UI may be generated based on a call received via the wireless circuitry 336 (shown in FIG. 4). In one or more implementations (as discussed below), the UI element 344m make take the form of an emergency call UI element that is given priority, thus causing the UI element 344b to reduce in area (e.g., to the location 350). Moreover, depending on whether the call is a non-emergency or emergency call, the operating system 326a or the operation system 326b, respectively, may be utilized to render the UI element 344m. As an example, the area of the UI element 344b may be automatically reduced to the location 350 based on the vehicle detecting an incoming phone call to a passenger(s) or an outgoing phone call from a passenger(s) in the vehicle.

Referring to FIG. 7D, the UI element 344b is relocated to a location 354, represented by the locations 342a and 342b (shown in FIG. 5). As shown, the area of the location 354 is the same as the area of the location 350 (shown in FIG. 7C). In this regard, the location 342c of the region 340a may be utilized for rendering the UI element 344m. Additionally, the location 342d of the region 340a may be utilized for rendering a UI element 344n that takes the form of a media UI (e.g., media playback and/or volume adjustment of a media file). As an example, the area of the UI element 344b may be automatically reduced to the location 354 based on a media file (e.g., music file) being played in the vehicle.

Referring to FIG. 7E, each of the locations 342a, 342b, 342c, and 342d of the region 340a are utilized for rending a respective UI element. For example, the location 342a is utilized for rendering the UI element 344l (e.g., maneuver UI), the location 342b is utilized for rendering the UI element 344o (e.g., windshield wiper UI, including windshield wiper speed UI), the location 342c is utilized for rendering the UI element 344p (e.g., battery efficiency UI), and the location 342d is utilized for rendering the UI element 344q (e.g., tire pressure UI).

It should be noted that each of the UI elements shown in FIG. 7E may be small-area representations of a larger-area UI element. For example, the UI element 344l may represent a map UI (e.g., UI element 344b shown in FIG. 7A). Also, the UI element 344o may represent a multi-speed selection UI (e.g., multiple, different windshield wiper speed). As an example, the UI element 344o may be automatically rendered by the operating system 326b when a rain sensor of the vehicle detects rain or precipitation.

Also, in one or more implementations, the UI element 344q may be prioritized based on certain context. For example, when the tire pressure of one or more tires of the vehicle falls below a threshold tire pressure, the UI element 344q may be prioritized, thus causing the UI element 344q to replace another UI element or be superimposed over another UI element. As an example, the UI element 344p may be automatically rendered by the operating system 326b when a tire pressure sensor(s) of the vehicle detects tire pressure below a threshold tire pressure.

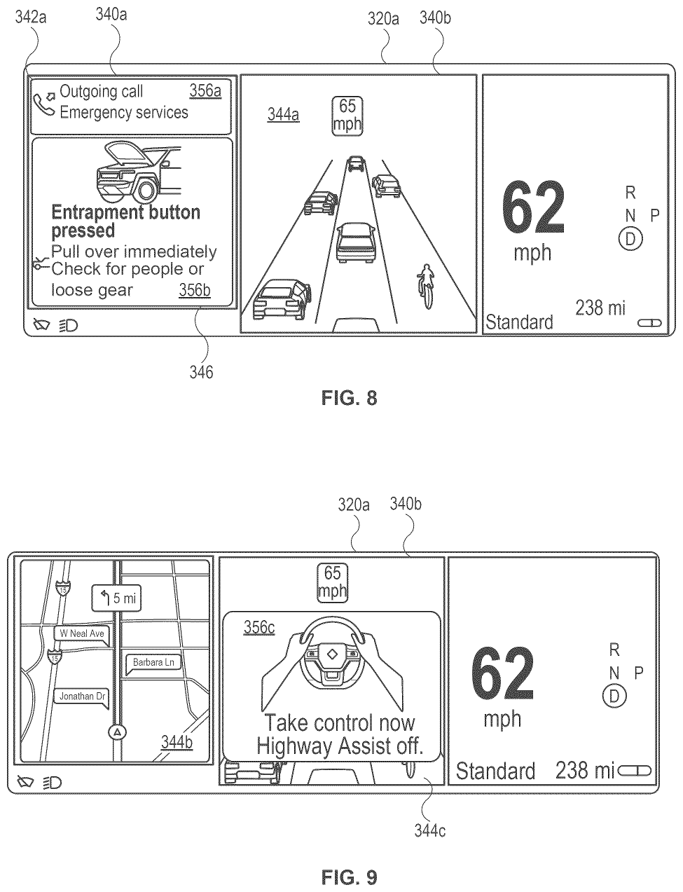

FIG. 8 and FIG. 9 illustrate examples of UI elements in the form of emergency-based notifications that may be rendered on the display 320a, in accordance with aspects of the present disclosure. Referring to FIG. 8, a UI element 356a takes the form of an emergency SOS outgoing call UI. The UI elements 356a may be rendered by the operating system 326b (shown in FIG. 4) in response to an event. As non-limiting examples, the event may include detection of an accident to the vehicle or detection of a failing or faulty component(s) of the vehicle. The one or more sensors 334 (shown in FIG. 4) may include a sensor, or sensors, to detect such events. Also, the operating system 326b may render the UI element 356a to replace another UI element rendered by the operating system 326a. For example, the UI element 356a, rendered by the operating system 326b, may replace the UI element 344a (shown in FIG. 6A as a navigation UI) rendered by the operating system 326a. In this regard, the operating system 326b, capable of rendering emergency-based notification UI elements and/or urgency-based notification UI elements, may be utilized to render preferential UI elements to replace a UI element rendered by the operating system 326a (shown in FIG. 4) that is of a lower preference or lower priority.

Also, a UI element 356b takes the form of an emergency notification UI. As an example, the one or more sensors 334 (shown in FIG. 4) may include a sensor that monitors (e.g., constantly monitors) for an event, such as a depression of a button within a front trunk, or frunk, region of a vehicle. When the sensor detects the event (e.g., actuation of the button) and the one or more processors 322 (shown in FIG. 4) determine the vehicle is moving, the one or more processors 322 may utilize the operating system 326b (shown in FIG. 4) to generate the UI element 356b that warns passengers with a notification that the button is depressed, and instructs the passengers to survey the front trunk.

As shown, the UI element 356b occupies an area defined by the location 346, which is defined by multiple locations, or sub-regions, of the region 340a. Moreover, the UI element 356b may be rendered and superimposed over another UI element. For example, referring to FIG. 6A showing the UI element 344b in the location 346. The UI element 356b (in FIG. 8) may be superimposed over the UI element 356b. In this regard, the operating system 326b, capable of rendering emergency-based notification UI elements, may be utilized to render a UI element that is superimposed over a UI element rendered by the operating system 326a (shown in FIG. 4). Other examples of UI elements not shown in FIG. 8 include an emergency-based notification UI based on the one or more sensors 334 (shown in FIG. 4) detecting a door and/or a hood of a vehicle is opened. It should be noted that the one or more processors 322 (shown in FIG. 4) determines the context of the UI elements 356a and 356b in order to determine the UI elements 356a and 356b are prioritized UI elements.

Referring to FIG. 9, a UI element 356c takes the form of an ADAS takeover UI instructing the driver to hold the steering wheel. As an example, the one or more sensors 334 (shown in FIG. 4) may include a sensor or sensors that monitors (e.g., constantly monitors) for an event, such as external hazards or whether the driver is paying attention. When the sensor(s) detects the event, or events, and the one or more processors 322 (shown in FIG. 4) determine the vehicle is moving, the one or more processors 322 (shown in FIG. 4) may utilize the operating system 326b (shown in FIG. 4) to generate the UI element 356c that warns and instructs passengers to hold the steering wheel. Also, the UI element 356c may be superimposed, or at least partially superimposed, over the UI element 344c (also shown in FIG. 6A) located in the region 340b. Accordingly, the operating system 326b may again be utilized to render UI elements over UI elements rendered by the operating system 326a (shown in FIG. 4). It should be noted that the one or more processors 322 (shown in FIG. 4) determines the context of the UI element 356c in order to determine the UI element 356c is a prioritized UI element.

It should be noted that a UI element associated with an emergency-based notification UI element and/or urgency-based notification UI element may replace or be superimposed over another UI element(s) that is/are not associated with an emergency-based notification UI element and/or urgency-based notification UI element. Otherwise, user elements (e.g., user element 344m shown in FIG. 7C, user element 344n shown in FIG. 7D) will be presented at a location (e.g., location 342d shown in FIG. 7D) of a display in accordance with a user input or user command to the display (e.g., by a user interacting/touching the display 320a shown in FIG. 6A).

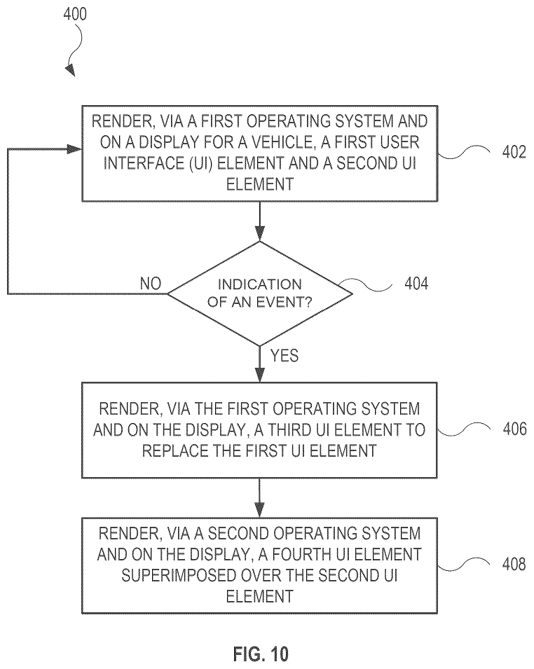

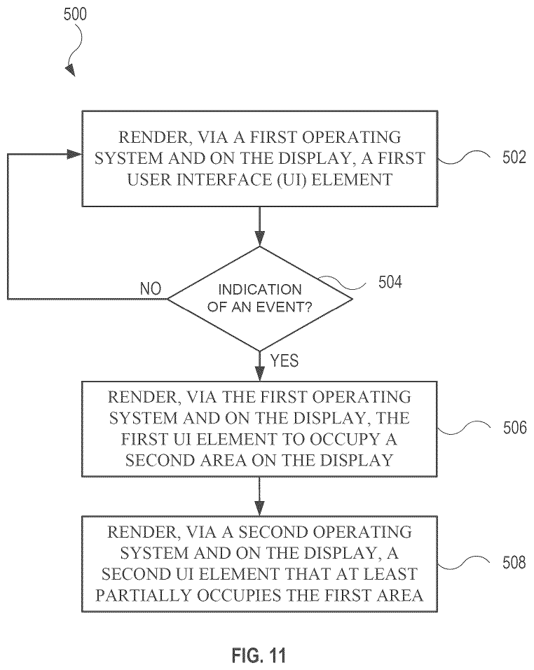

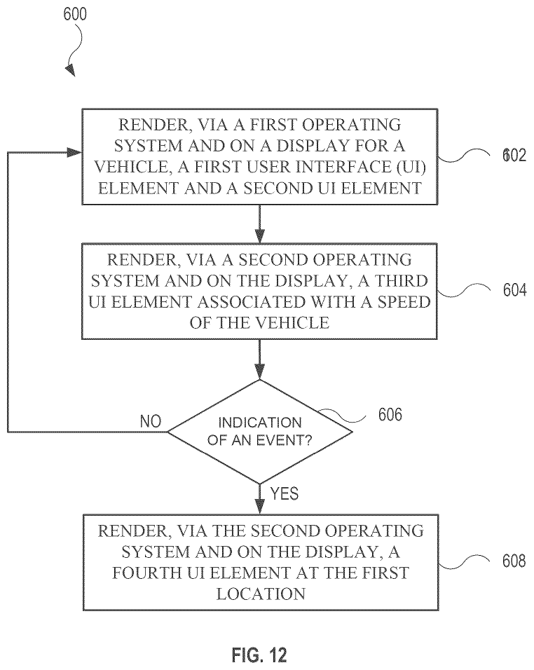

FIG. 10, FIG. 11, and FIG. 12 illustrate flow diagrams showing example processes that may be performed for managing a display in a vehicle, in accordance with implementations of the subject technology. For explanatory purposes, the processes is primarily described herein with reference to features shown in one or more FIGS. 3-9, including the one or more processors 322, the operating system 326a and 326b, the one or more displays 330, and the one or more sensors 334 (all shown in FIG. 4). However, the processes are not limited to the features shown in one or more FIGS. 3-9, and one or more blocks (or operations) of the processes may be performed by one or more other components of other suitable moveable apparatuses, devices, or systems. The processes shown and/or described in FIGS. 10-12 may be stored on a non-transitory computer-readable medium as computer-readable instructions that are executed by one or more processors. Further for explanatory purposes, some of the blocks of the processes are described herein as occurring in serial, or linearly. However, multiple blocks of the processes may occur in parallel. In addition, the blocks of the processes need not be performed in the order shown and/or one or more blocks of the processes need not be performed and/or can be replaced by other operations.

FIG. 10 illustrates a flow diagram showing a process 400 for managing a display in a vehicle, in accordance with one or more aspects of the present disclosure. At block 402, a first user interface (UI) element and a second UI element are rendered via a first operating system (e.g., operation system 326a shown in FIG. 4) and on a display (e.g., display 320a shown in FIG. 4) for a vehicle (e.g., vehicle 300 shown in FIG. 4).

At block 404, a determination is made whether an indication of an event has occurred. As non-limiting examples, the event make take the form of an emergency situation, an accident incurred by the vehicle, a button depressed within the front trunk, or an emergency outgoing call. The determination of the indication may be determined by, for example, the one or more sensors 334 (shown in FIG. 4). If the determination indicates the event has not occurred, the process 400 returns to block 402. If the determination indication the event has occurred, the process 400 proceeds to block 406.

At block 406, a third UI element is rendered to replace the first UI element is rendered via the first operating system and on the display. In one or more implementations, the third UI element is rendered by a second operating system (e.g., operating system 326b shown in FIG. 4). In this regard, the third UI element may take the form of an emergency-based UI element and/or an urgency-based UI element.

At block 408, a fourth UI element is rendered, via a second operating system and on the display, and is superimposed over the second UI element. The fourth UI element is associated with the event. An event may include emergency-based events or other prioritized events.

Alternatively, in one or more implementations, a process may include rendering, via a first operating system and on a display for a vehicle, a first user interface (UI) element and a second UI element; and in response to an indication of an event, via the first operating system and on the display, adjusting the first UI element and the second UI element. In this regard, a single operating system (e.g., first operation system) may be utilized to render UI element and adjust the rendered UI elements.

FIG. 11 illustrates an alternate flow diagram showing a process 500 for managing a display in a vehicle, in accordance with one or more aspects of the present disclosure. At block 502, a first user interface (UI) element is rendered via a first operating system (e.g., operating system 326a shown in FIG. 4) and on a display (e.g., display 320a shown in FIG. 4). The first UI element occupies a first area on the display (e.g., at the region 340a shown in FIG. 5).

At block 504, a determination is made whether an indication of an event has occurred. As non-limiting examples, the event make take the form of an emergency situation, an accident incurred by the vehicle, a button depressed within the front trunk, or an emergency outgoing call. The determination of the indication may be determined by, for example, the one or more sensors 334 (shown in FIG. 4). If the determination indicates the event has not occurred, the process 500 returns to block 502. If the determination indicates the event has occurred, the process 500 proceeds to block 506.

At block 506, the first UI element is rendered, via the first operating system and on the display, to occupy a second area on the display. The second area may be different from the first area. For example, the second area is less than the first area.

At block 508, a second UI element is rendered, via a second operating system (e.g., operating system 326b shown in FIG. 4) and on the display, and at least partially occupies the first area. The second UI element may be associated with the event. An event may include emergency-based events or other prioritized events. For example, the third second element may take the form of an emergency-based UI element and/or an urgency-based UI element.

FIG. 12 illustrates an alternate flow diagram showing a process 600 for managing a display in a vehicle, in accordance with one or more aspects of the present disclosure. At block 602, a first user interface (UI) element and a second UI element are rendered via a first operating system (e.g., operation system 326a shown in FIG. 4) and on a display (e.g., display 320a shown in FIG. 4) for a vehicle (e.g., vehicle 300 shown in FIG. 4). The first UI element may be rendered at a first location of the display. Also, the first UI element may include navigation information. The second UI element may include an environment in which the vehicle is located. The environment may include detected vehicles surrounding the vehicles.

At block 604, a third UI element is rendered via a second operating system (e.g., operation system 326b shown in FIG. 4) and on the display. The third UI element may be associated with a speed of the vehicle.

At block 606, a determination is made whether an indication of an event has occurred. As non-limiting examples, the event make take the form of an emergency situation, an accident incurred by the vehicle, a button depressed within the front trunk, or an emergency outgoing call. The determination of the indication may be determined by, for example, the one or more sensors 334 (shown in FIG. 4). If the determination indication the event has not occurred, the process 600 returns to block 602. If the determination indicates the event has occurred, the process 600 proceeds to block 608.

At block 608, rendering, via the second operating system and on the display, a fourth UI element at the first location. The fourth UI element is associated with the event. An event may include emergency-based events or other prioritized events.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
rendering, via a first operating system and on a display for a vehicle, a first user interface (UI) element and a second UI element; and
in response to an indication of an event, via the first operating system and on the display, adjusting the first UI element and the second UI element.

2. The method of claim 1, further comprising in response to the indication of the event:
rendering, via the first operating system and on the display, a third UI element to replace the first UI element, and
rendering, via a second operating system and on the display, a fourth UI element superimposed over the second UI element, wherein the fourth UI element is associated with the event.

3. The method of claim 2, wherein the fourth UI element comprises a notification UI associated with a notification UI associated with the vehicle or a call notification for a passenger of the vehicle.

4. The method of claim 2, wherein the first UI element, the second UI element, and the third UI element comprise navigational UI.

5. The method of claim 4, wherein at least some of the first UI element and the second UI element is combined to render the third UI element.

6. The method of claim 2, further comprising rendering, via the second operating system and on the display, a fifth UI element associated with a speed of the vehicle.

7. The method of claim 2, wherein the third UI element includes only text information.

8. The method of claim 2, wherein the fourth UI element comprises an emergency notification.

9. A device, comprising:
a display configured to present visual information for a vehicle;
memory; and
one or more processors configured to execute instructions stored on the memory, the instructions comprising:
rendering, via a first operating system and on the display, a first user interface (UI) element, wherein the first UI element occupies a first area on the display; and
in response to an indication of an event:
rendering, via the first operating system and on the display, the first UI element to occupy a second area on the display, the second area less than the first area, and
rendering, via a second operating system and on the display, a second UI element that at least partially occupies the first area, wherein the second UI element is associated with the event.

10. The device of claim 9, wherein the second UI element comprises a notification UI associated with the vehicle.

11. The device of claim 10, wherein the notification UI comprises an emergency notification UI.

12. The device of claim 9, wherein the instructions further comprise in response to the indication of the event:
rendering, via the first operating system and on the display, the first UI element to occupy a third area on the display, the third area less than the second area, and
rendering, via the second operating system and on the display, a third UI element that at least partially occupies the second area, wherein the third UI element is associated with the event.

13. The device of claim 9, wherein the instructions further comprise in response to the indication of the event:
the first UI element comprises a first portion of a navigation UI, and
the second UI element comprises a second portion of the navigation UI.

14. The device of claim 13, wherein:
the first portion comprises an environment in which the vehicle is located, and
the second portion comprises turn instructions.

15. The device of claim 9, wherein the second UI element comprises a widget UI selected from one of a media UI, a windshield wiper UI, a battery efficiency UI, or a tire pressure UI.

16. The device of claim 9, wherein the instructions further comprise receiving, via one or more sensors, data corresponding to the event.

17. A non-transitory computer-readable medium, comprising:
computer-readable instructions that, when executed by a processor, cause the processor to perform one or more operations comprising:
rendering, via a first operating system and on a display for a vehicle:
a first user interface (UI) element at first location of the display, the first UI element comprising navigation information,
a second UI element comprising an environment in which the vehicle is located;
rendering, via a second operating system and on the display, a third UI element associated with a speed of the vehicle; and
in response to an indication of an event, automatically rendering, via the second operating system and on the display, a fourth UI element at the first location, wherein the fourth UI element is associated with the event.

18. The non-transitory computer-readable medium of claim 17, wherein:
the first UI element occupies a first area on the display, and
the one or more operations further comprise in response to the indication of the event:
rendering, via the first operating system and on the display, the first UI element to occupy a second area on the display, the second area less than the first area, and
rendering, via the second operating system and on the display, the fourth UI element to at least partially occupy the first area.

19. The non-transitory computer-readable medium of claim 17, the one or more operations further comprise in response to the indication of the event, superimposing the fourth UI element over first UI element.

20. The non-transitory computer-readable medium of claim 17, wherein the fourth UI element is selected from a notification UI or a widget UI.
